(19) United States
(12) Patent Application Publication
(10) Pub. No.: US 2025/0248398 A1
(43) Pub. Date: Aug. 7, 2025

(54) TICK REPELLENT

(71) Applicant: Gerhard Gries, Coquitlam (CA)

(72) Inventors: Claire Gooding, Burnaby (CA); Regine Gries, Coquitlam (CA); Gerhard Gries, Coquitlam (CA)

(21) Appl. No.: 19/043,482

(22) Filed: Feb. 2, 2025

Related U.S. Application Data
(60) Provisional application No. 63/549,151, filed on Feb. 2, 2024.

(51) Int. Cl. A01N 31/06; A01N 25/02; A01N 27/00; A01N 37/02; A01P 17/00

(52) U.S. Cl. CPC A01N 31/06; A01N 25/02; A01N 27/00; A01N 37/02; A01P 17/00

(57) ABSTRACT

Tick repellents include one or more of 2-methylisoborneol (2-MIB), D-borneol, L-borneol, and a blend of formic acid, undecane, tridecane, (Z)-4-tridecene, heptadecane, (Z)-9-tricosene, pentadecane, (Z)-9-nonadecene, and (Z)-9-heneicosene; and a carrier material. A method of controlling ticks can include dispensing the tick repellent. Personal care products for topical application can include the tick repellent.

### REFERENCE TO RELATED APPLICATIONS

The present application claims the priority of U.S. provisional application Ser. No. 63/549,151, entitled TICK REPELLENT, filed Feb. 2, 2024, and hereby incorporates the same application herein by reference in its entirety.

### TECHNICAL FIELD

The present disclosure relates generally to a tick repellent as well as to devices and methods of using the tick repellent to repel ticks.

### BACKGROUND

Ticks are parasites that feed on a variety of vertebrate hosts, including humans. Blacklegged ticks, for example, carry human pathogens and parasites, including Borrelia burgdorferi, the causative agent of Lyme Disease, and can pass such pathogens and parasites to their human hosts. In the United States alone, there are an estimated 300,000 cases of Lyme Disease annually. Accordingly, there is a strong medical interest in preventing the parasitic activity of ticks on human hosts. Measures to prevent tick bites and thus the potential transmission of pathogens and parasites can be enhanced by repelling, or deterring, ticks from climbing onto humans. What is desired is a tick repellent that effectively and efficiently repels and/or deters ticks from climbing onto humans and from entering and questing in areas frequented or occupied by humans.

### SUMMARY

According to one embodiment, a tick repellent includes one or more of 2-methylisoborneol (2-MIB); D-borneol; L-borneol; and a blend of formic acid, undecane, tridecane, (Z)-4-tridecene, heptadecane, (Z)-9-tricosene, pentadecane, (Z)-9-nonadecene, and (Z)-9-heneicosene, and a carrier material.

According to another embodiment, a device for repelling one or more ticks includes a housing and a tick repellent transferable to the housing. The tick repellent includes one or more of 2-methylisoborneol (2-MIB), D-borneol, L-borneol, and a blend of formic acid, undecane, tridecane, (Z)-4-tridecene, heptadecane, (Z)-9-tricosene, pentadecane, (Z)-9-nonadecene, and (Z)-9-heneicosene; and a carrier material.

According to another embodiment, a method of controlling ticks includes dispensing a tick repellent, wherein the tick repellent includes one or more of 2-methylisoborneol (2-MIB), D-borneol, L-borneol, and a blend of formic acid, undecane, tridecane, (Z)-4-tridecene, heptadecane, (Z)-9-tricosene, pentadecane, (Z)-9-nonadecene, and (Z)-9-heneicosene; and a carrier material.

### BRIEF DESCRIPTION OF THE DRAWINGS

FIG. 1a depicts a perspective view of an apparatus used to test behavioral responses of ticks to synthetic fungal metabolites;

FIG. 1b depicts a top view of the apparatus of FIG. 1a;

FIG. 1c depicts a cross-sectional view of the apparatus of FIG. 1a;

FIG. 2 depicts a side view of an apparatus used to test behavioral responses of ticks to natural and synthetic ant metabolites;

FIG. 3 depicts results of two-choice experiments demonstrating that 2-methylisoborneol (2-MIB) dissolved in methanol deters blacklegged ticks;

FIG. 4 depicts results of two-choice experiments demonstrating that each of 2-MIB and a combination of D-borneol and L-borneol, dissolved in methanol, deter blacklegged ticks;

FIG. 5 depicts results of two-choice experiments demonstrating that 2-MIB dissolved in methanol deters ticks of three species;

FIG. 6 depicts results of two-choice experiments demonstrating that chemical deposits of Formica oreas ants deter female and male blacklegged ticks;

FIG. 7 depicts results of two-choice experiments demonstrating that combined dichloromethane (DCM) extracts of the poison gland and the Dufour's gland of Formica oreas ants deter female and male blacklegged ticks; and

FIG. 8 depicts results of two-choice experiments demonstrating that a synthetic blend of poison gland and Dufour's gland constituents of Formica oreas ants deters female and male blacklegged ticks.

### DETAILED DESCRIPTION

The term “isolated” as used herein means separated from materials with which the compound is normally associated in a native state.

The term “purified” as used herein refers to material that has been isolated under conditions that reduce, or eliminate, the presence of unrelated materials, i.e., contaminants, including native materials from which the material is obtained. Purified materials, substantially free of contaminants, can be 50% or more pure; 90% or more pure, or 99% or more pure. Purity can be evaluated by methods known in the art.

The term “synthetic” as used herein means artificially produced by chemical processes or other processes initiated by human activity, as opposed to compounds formed by natural processes.

The term “repellent” as used herein refers to any compositions, blends, or formulations that repel, or deter, a tick or ticks, from a vertebrate host, habitat, or other sites which may otherwise be frequented or traversed by a tick or ticks.

The present disclosure generally relates to tick repellents for repelling, or deterring, one or more species of ticks. Generally, the tick repellents can include one or more of 2-MIB, and D-borneol and L-borneol. The tick repellent can include one or more ant pheromone components. For example, tick repellents can include a blend of formic acid, undecane, tridecane, (Z)-4-tridecene, heptadecane, (Z)-9-tricosene, pentadecane, (Z)-9-nonadecene, and (Z)-9-heneicosene. The tick repellent can further include a carrier material. The tick repellent can act to deter at least species of hard ticks, such as Ixodes ticks. More specifically, such species can include black-legged ticks, Ixodes scapularis; lone star ticks, Amblyomma americanum; and American dog ticks, Dermacentor variabilis. The tick repellent can also act to deter species of soft ticks, such as those carrying disease-causing pathogens.

As can be appreciated, certain ticks, such as hard ticks and/or non-nidicolous ticks, must seek vertebrate hosts and attempt to pursue and climb onto hosts in order to survive. Accordingly, the availability of hosts, questing locations, and off-host microhabitats can affect the behavior, survival, and distribution of such ticks. In addition to exhibiting an ability to detect cues indicative of host presence, ticks can also have the ability to exploit chemical cues indicative of predator presence. Such cues can influence the behavior and presence of ticks. The results of Examples 1-3, described herein, indicate that, unexpectedly, ticks avoid 2-MIB, which is commonly emitted by bacteria and fungi, such that the presence 2-MIB may inform ticks of potential threats to be avoided. Similarly, as shown in Example 2, a blend of D-borneol and L-borneol was also unexpectedly found to be a deterrent to ticks.

Therefore, in certain embodiments, the tick repellent can include 2-MIB. For example, in certain embodiments, the tick repellent can include about 0.0000004% (weight by volume (w/v)) or more of 2-MIB; in certain embodiments, about 0.000004% (w/v) or more of 2-MIB; in certain embodiments, about 0.00004% (w/v)or more of 2-MIB; in certain embodiments, about 0.0004% (w/v) or more of 2-MIB; in certain embodiments, about 0.004% (w/v) or more of 2-MIB; in certain embodiments, about 0.04% (w/v) or more of 2-MIB; in certain embodiments, about 0.4% (w/v) or more of 2-MIB; in certain embodiments, about 4% (w/v) or more of 2-MIB; and in certain embodiments, about 40% (w/v) or more of 2-MIB. It will be appreciated, however, that 2-MIB can be included in a tick repellent in any of a variety of suitable percentages.

In certain embodiments, the tick repellent can include one or more of D-borneol and L-borneol. For example, the tick repellent can include a blend of D-borneol and L-borneol. In certain embodiments, the tick repellent can include about 0.0000004% (weight by volume (w/v)) or more of one or both of D-borneol and L-borneol; in certain embodiments, about 0.000004% (w/v) or more of one or both of D-borneol and L-borneol; in certain embodiments, about 0.00004% (w/v) or more of one or both of D-borneol and L-borneol; in certain embodiments, about 0.0004% (w/v) or more of one or both of D-borneol and L-borneol; in certain embodiments, about 0.004% (w/v) or more of one or both of D-borneol and L-borneol; in certain embodiments, about 0.04% (w/v) or more of one or both of D-borneol and L-borneol; in certain embodiments, about 0.4% (w/v) or more of one or both of D-borneol and L-borneol; in certain embodiments, about 4% (w/v) or more of one or both of D-borneol and L-borneol; and in certain embodiments, about 40% (w/v) or more of one or both of D-borneol and L-borneol. In certain embodiments, the tick repellent can include D-borneol and L-borneol in a 1:1 ratio. It will be appreciated, however, that D-borneol and L-borneol can be included in a tick repellent in any of a variety of suitable ratios.

In certain embodiments, the 2-MIB included in the tick repellent can be isolated, purified, or synthetic. Likewise, in certain embodiments, the components of the blend of D-borneol and L-borneol included in the tick repellent can be isolated, purified, or synthetic.

In addition to the findings described above, it has been unexpectedly discovered that ticks can eavesdrop on the communication signals of ants. That is, the results of Examples 4-6, described herein, indicate that ticks avoid ant pheromone components, indicators of ant presence, in an apparent effort to avoid predation by ants. It will further be appreciated that extracts of poison and Dufour's glands of ants, which can serve as alarm-recruitment pheromone components to ant nestmates and are likely to be present in areas that ants frequent, can also have a deterrent effect on ticks.

For example, Table 1, provided herein, shows the mean amounts of chemical constituents quantified in poison and Dufour's gland extracts of Formica oreas worker ants. In certain embodiments, the tick repellent can include extracts from poison and Dufour's glands of ants. In such embodiments, the poison and Dufour's gland extracts can be those of Formica oreas worker ants. For example, extracts for the poison gland can include formic acid, while extracts from the Dufour's gland can include several hydrocarbons, including undecane, tridecane, (Z)-4-tridecene, heptadecane, (Z)-9-tricosene, pentadecane, (Z)-9-nonadecene, and (Z)-9-heneicosene. Therefore, in certain embodiments, tick repellents can include ant pheromone components. In certain embodiments, ant pheromone components can include a blend of formic acid, undecane, tridecane, (Z)-4-tridecene, heptadecane, (Z)-9-tricosene, pentadecane, (Z)-9-nonadecene, and (Z)-9-heneicosene. It will be appreciated, however, that the tick repellent can include any of a variety of pheromone components from other ant species.

In certain embodiments, the components of the Formica oreas ant pheromone blend of formic acid, undecane, tridecane, (Z)-4-tridecene, heptadecane, (Z)-9-tricosene, pentadecane, (Z)-9-nonadecene, and (Z)-9-heneicosene included in the tick repellent can be isolated, purified, or synthetic.

In certain embodiments, the tick repellent can include Formica oreas ant pheromone components at the same blend ratio as found in exocrine glands of these ants (formic acid: about 12.1%; undecane: about 72.65%; tridecane: about 6.2%; (Z)-4-tridecene: about 4.36%; heptadecane: about 1.38%; (Z)-9-tricosene: about 1.09%; pentadecane: about 0.97%; (Z)-9-nonadecene: about 0.97%, (Z)-9-heneicosene: about 0.29%). It will be appreciated, however, that pheromone components can be included in a tick repellent in any of a variety of ratios.

The tick repellent can include any of a variety of suitable carrier liquids, such as organic solvents. For example, suitable carrier liquids can include methanol, water, DCM, hexane, ether, and acetonitrile. In other embodiments, the carrier material for the tick repellent can be an inert material that can be skin-friendly and can include creams, foams, gels, lotions, and ointments. It will be appreciated that any of a variety of other, suitable carrier material can be included in the tick repellent.

In certain embodiments, the tick repellent can include or consist of methanol, as a carrier liquid, and 2-MIB. In certain embodiments, the tick repellent can include or consist of methanol, as a carrier liquid, and a blend of D-borneol and L-borneol. In certain embodiments, the tick repellent can include or consist of DCM, as a carrier liquid, and a blend of formic acid, undecane, tridecane, (Z)-4-tridecene, heptadecane, (Z)-9-tricosene, pentadecane, (Z)-9-nonadecene, and (Z)-9-heneicosene.

It will be appreciated that the tick repellent may include any of a variety of suitable, additional components. For example, in certain embodiments, the tick repellents can further include extracts from other exocrine glands, such as mandibular glands, which can include for example, citronellol, citronellal, cis-citral, limonene, cymen, methyl salicylate, and geranial. In certain embodiments, the tick repellents may further include plant essential oils. Suitable plant essential oils can include, for example, lavender, sandalwood, cypress, juniper, juniper berry, cedarwood, amyris, bergamot, rose, rosemary, jasmine, oregano, citronella, cinnamon bark, cinnamon leaf, clove bud, blue, tansy, geranium, lemongrass, lemon, lemon eucalyptus, licorice root, spearmint, peppermint, neem seed, creeping thyme, red thyme, wintergreen, patchouli, peppermint, cassia, and eugenol.

As described herein, the tick repellent can be used to deter hard ticks, such as Ixodes ticks. In certain embodiments, the hard ticks can be non-nidiculous ticks, which actively seek hosts outside of burrows. Examples of ixodid ticks can include blacklegged ticks, Ixodes scapularis; lone star ticks, Amblyomma americanum; and American dog ticks, Dermacentor variabilis. Other examples of ixodid ticks can include brown dog ticks, Rhipicephalus sanguineus; castor bean ticks, Ixodes Ricinus; and western blacklegged ticks, Ixodes pacificus. In other embodiments, the tick repellent can be used to deter species of soft ticks, such as those carrying disease-causing pathogens. It will be appreciated, however, that a tick repellent can be used for any of a variety of tick species.

Methods for controlling ticks can include applying, dispensing, or disseminating a tick repellent as described herein. For example, in certain embodiments, tick repellents can be incorporated into a personal care product, such as a lotion, topical aerosol, topical spray solution. In other embodiments, the personal care product can be incorporated into an application sheet, e.g., a towelette. In certain embodiments, personal care products can be applied topically to a user's skin. In other embodiments, tick repellents can be directly sprayed onto clothing and areas where tick may be problematic, such as outdoor patios, yards, vegetation, and trails. In certain embodiments, tick repellents can be impregnated into clothing.

In certain embodiments, the tick repellents described herein can be formulated in any suitable fashion to facilitate passive volatilization or active dissemination. For example, tick repellents can be soaked into, or on, a medium such as filter paper for volatilization or be actively dispensed using a dispensing mechanism. As can be appreciated, the types of media that tick repellents can be soaked into, or on, can vary widely. For example, tick repellents can be soaked into papers, beddings, woodchips, and outdoor surfaces in various embodiments. As can be appreciated, the duration and intensity of the repellent effect can vary depending upon the type of dispensing medium selected.

In certain embodiments, the tick repellent can also, or alternatively, be formulated as a granule, a solid block, a gel, a lotion, an ointment, a powder, a paste, a liquid, an aerosolized composition, or as combinations thereof. As can be appreciated, the tick repellents described herein can be applied in any of a variety of suitable manners. For example, the tick repellents can be applied as a liquid, cream, a gel, a lotion, an ointment, or as an aerosol, using appropriate carriers or devices.

In certain embodiments, a device can be provided for repelling ticks. In such embodiments, the device can include a housing to which the tick repellent can be transferable. In certain embodiments, the tick repellent can be dispensed or disseminated from the device. As can be appreciated, a device can be useful to effectively control the rate of dissemination, to disseminate greater quantities of the tick repellents, and to increase the amount of tick repellents that is available for dissemination, thereby extending the longevity of the repellent effect. Additionally, a device provides the option, for example, to insert a new repellent-filled cartridge or to refill an empty cartridge or reservoir.

In certain embodiments, a device engineered to disseminate the tick repellent can include a reservoir, within or exterior to the housing, to store the tick repellent and one or more mechanisms to disseminate the repellents into the surrounding environment. For example, in certain embodiments, the reservoir can be heated to a temperature suitable for efficient or controlled volatilization of the tick repellent compounds. In such embodiments, the desired temperature of the reservoir can be obtained by chemical reactions (e.g., through reaction of iron-containing compositions with air, recrystallization of a supersaturated sodium acetate composition, etc.) or by electrical energy (e.g., through attachment to a battery, solar panel, or a plug-in connection to the power grid), thereby heating the tick repellent to a suitable temperature, such as a temperature of about 40° C.

As can be appreciated, variations to such devices are contemplated. For example, suitable devices can alternatively include separate reservoirs and heated chambers in certain embodiments. In such embodiments, capillary action or wicks can be used to transfer the tick repellent into the heated chamber for volatilization. Additionally, or alternatively, a device can include a fan to physically dispense the tick repellent through powered air flow.

In certain embodiments, the tick repellents can be disseminated using multiple methods simultaneously. For example, in certain embodiments, it can be useful to apply a personal care product including a tick repellent to a user's skin while also, more generally, disseminating a tick repellent from a device to more generally deter ticks from a particular area.

In certain embodiments, the tick repellent can be particularly effective to control ticks when used in combination with tick attractants. For example, a combination of the present tick repellents with a tick attractant can operate as a “push-pull” system that repels ticks from certain locations while attracting ticks to other specific locations. Such systems can prevent ticks from overcoming the deterrent effect of the tick repellents by attracting those ticks to specific locations where they can be better controlled and/or trapped. Suitable tick attractants can include tick pheromones, vertebrate host cues (e.g., skin semiochemicals, carbon dioxide, body heat, body infrared radiation), and cues from microbes residing on the skin or in gland secretion of vertebrate hosts.

### EXAMPLES

In preparation for testing the effect of naturally-occurring deterrents on ticks, several species of ticks were obtained, including females and males of three species of ixodid ticks that are taxonomically diverse and of medical and/or veterinary importance: the black-legged tick, Ixodes scapularis, the lone star tick, Amblyomma americanum, and the American dog tick, Dermacentor variabilis. All ticks were obtained from BEI Resources (American Type Culture Collection), and additional I. scapularis adults were purchased from the National Tick Research and Education Resource (Oklahoma State University).

Groups of 10-12 ticks were housed in 20-mL glass scintillation vials (VWR International, PA, U.S.A) fitted with strips of paper towel as refuge and substrate for climbing, and with a mesh-covered hole (˜1 cm) in the lid to enable air exchange. As ticks are prone to desiccation, vials were kept at high relative humidity (85-95%) in a vessel (with a diameter of 26 cm and a height of 30 cm) containing a saturated solution of K₂SO₄ (99% purity; Alfa Aesar, ON, Canada). To minimize the risk of tick escape, the vessel was retained in a plexiglass box (50 cm×35 cm×35 cm), which was kept at a temperature of 22° C. and a 14:10 light/dark cycle. To prevent mold/fungal growth, vials were washed weekly with Sparkleen (Thermo Fisher Scientific, MA, U.S.A) and dried at a temperature of 100° C. for at least 1 hour. Monthly, the vessel was washed and sterilized with Sparkleen and 70% ethanol, respectively, and the K₂SO₄ solution was replaced.

Colonies of Formica oreas ants were collected in Surrey, B.C., Canada (49° 10′04.7″N 122° 41′57.8″W) in August 2020. Colonies were housed in plastic bins (66 cm×40 cm×35 cm) filled halfway with nesting material from collection sites. Bins were kept in the Science Research Annex (49° 16′33.5″N 122° 54′55.0″W) on the Burnaby campus of Simon Fraser University and exposed to a 12:12 light/dark cycle. Ants were provisioned with mealworms, Tenebrio molitor; German cockroaches, Blattella germanica; American cockroaches, Periplaneta americana; apple slices; and a 20% sugar water solution ad libitum.

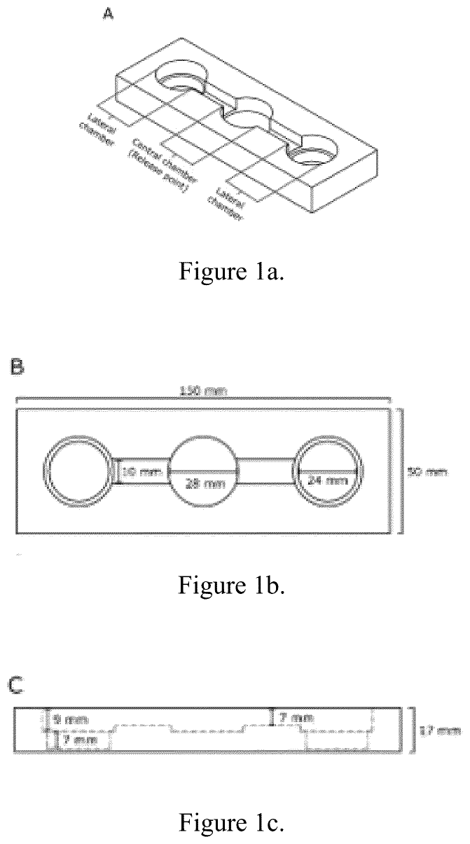

All behavioral responses of ticks to experimental substrates were tested in two-choice still-air olfactometers (150 mm×50 mm×17 mm; FIGS. 1a, 1b, 1c). Still-air, instead of moving-air, olfactometers were used because off-host ticks encounter fungi in soil microhabitats such as leaf litter where there is typically little, if any, air movement. Each olfactometer had three inset circular chambers (with an inner diameter of 28 mm) interconnected with inset linear paths (24 mm×10 mm×7 mm). The central chamber had a depth of 7 mm, whereas the lateral chambers had a depth of 16 mm with a 2-mm wide lip of 9-mm depth to accommodate a 9-mm thick watch glass.

Olfactometers were modeled and 3D-printed using Autodesk Fusion 360 (Version 13.2.0.9150), Creality Slicer (Version 4.8.2), and an Ender-3 Pro 3D printer (Creality, Shengzhen, China). Olfactometers were printed using translucent 1.75 mm (±0.03 mm dimensional accuracy) polylactic acid (PLA) filament (GIANTARM, OH, U.S.A.). To reduce the porosity of 3D-printed olfactometers, XTC-3D brush-on epoxy coating was applied (Smooth-On Inc., PA, U.S.A.).

Treatment and control test stimuli were assigned to lateral chambers, alternating the position of stimuli between replicates to account for potential side bias. To initiate an experimental replicate, a single tick was introduced into the central chamber, briefly exposed to human exhale to stimulate movement, and then allowed 30 minutes to respond. A 30-minute bioassay time was deemed sufficient because in pre-screening tests, 80% of female I. scapularis left the central olfactometer chamber within 30 minutes. Olfactometers were sealed with parafilm and a rectangular lid (150 mm×50 mm×3 mm).

A tick was considered a responder if it was found in a lateral chamber after 30 minutes. All other ticks were deemed non-responders and excluded from statistical analyses but were reported in figures. After each experiment, olfactometers were cleaned with 70% ethanol and hexane. At the end of each experimental day, olfactometers were washed with Sparkleen (Thermo Fisher Scientific, MA, U.S.A), rinsed with distilled water, and air-dried.

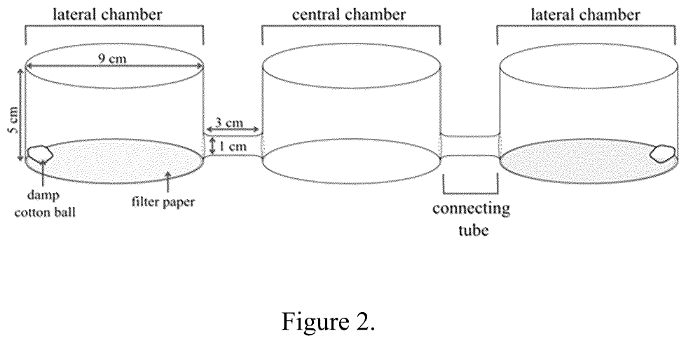

Deterrent effects of ant metabolites on behavioural responses of ticks were bioassayed in still-air Pyrex glass olfactometers, as shown in FIG. 2, consisting of one central chamber and two lateral chambers (each having a diameter of 9 cm and a height of 5 cm), linearly interconnected by glass tubes (having a diameter of 1 cm and a length of 3 cm). Treatment and control stimuli were assigned to the two lateral chambers, alternating the position of stimuli between replicates to account for potential side bias. Both lateral chambers were also fitted with a wet cotton ball (Thermo Fisher Scientific, MA, U.S.A.) to ensure sufficiently high humidity.

To initiate an experimental replicate, a single I. scapularis tick was introduced into the central chamber, briefly exposed to human exhale to stimulate movement, and then allowed 20 hours to respond. A tick was considered a responder if it was found in a lateral chamber or in a connecting glass tube closer to a lateral chamber than the central chamber, as shown in FIG. 2. All other ticks were deemed non-responders and excluded from statistical analyses but were reported in figures. To prevent tick escape, all three chambers of the olfactometer were sealed with Parafilm (Bemis, WI, U.S.A.) for the duration (i.e., 20 hours) of the experiment.

To minimize the potential for tick escape, and to prevent ticks from sensing cues (e.g., convective heat, infrared radiation, CO₂) originating from experimentalists that initiated or scored experiments, olfactometers (n=10-15) were housed in a plexiglass box (112 cm×24 cm×14 cm). Experiments were run under a 14:10 light/dark cycle, thus enabling ticks to respond to test stimuli while maintaining a circadian rhythm. After each experiment, olfactometers were washed with Sparkleen (Thermo Fisher Scientific), thoroughly rinsed with distilled water, and dried at a temperature of 100° C. for at least 1 hour.

### Example 1

Various soil-dwelling fungi emit airborne 2-methylisoborneol and geosmin. Both compounds are invariably present at the soil surface but their concentrations increase significantly when soil is disturbed. As soil disturbances can physically harm ticks, Experiments 1-6 were conducted to determine whether ticks avoid settling in locations with elevated concentrations of 2-methylisoborneol and geosmin.

In Experiments 1-6, a watch glass (28 mm diameter) fitted with a congruent piece of filter paper was placed in lateral olfactometer chambers, as shown in FIGS. 1a, 1b, and 1c, and 2-MIB dissolved in 25 μL of methanol was applied at doses of 1.0 ng (Exp. 1), 0.1 ng (Exp. 2), and 0.01 ng (Exp. 3) to the treatment filter paper, and 25 μL of methanol was applied to the corresponding control filter paper. Similarly, geosmin dissolved in 25 μL of methanol was applied at doses of 1.0 ng (Exp. 4), 0.1 ng (Exp. 5), and 0.01 ng (Exp. 6), using 25 μL of methanol as the control stimulus. In each experimental replicate, methanol was allowed 5 minutes to evaporate before a tick was introduced into the central olfactometer chamber.

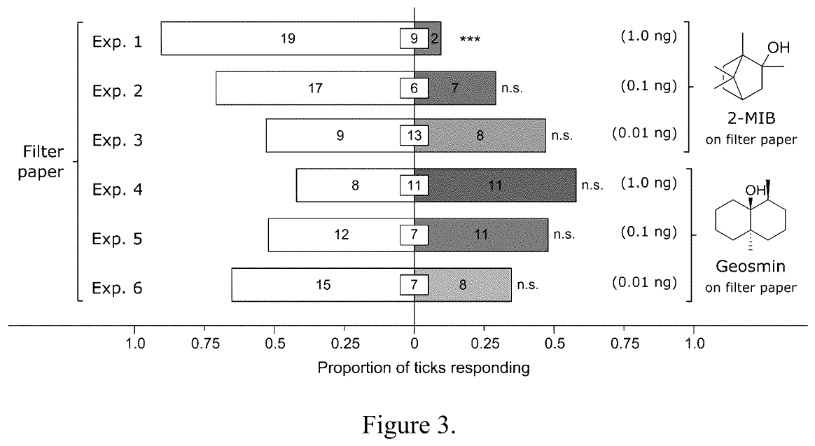

2-MIB, but not geosmin, affected behavioral responses of ticks, as shown in FIG. 3. Female I. scapularis were strongly deterred by 2-MIB at a dose of 1 ng (Exp. 1: exact binomial test: n=21, p=0.0002), moderately deterred at a dose of 0.1 ng (Exp. 2: exact binomial test: n=24, p=0.064), but not deterred at a dose of 0.01 ng (Exp. 1: exact binomial test: n=17, p=1). Conversely, irrespective of the dose tested, female I. scapularis ticks were not deterred by geosmin. For example, female I. scapularis ticks were not deterred by geosmin at a dose of 1 ng (Exp. 4: exact binomial test: n=19, p=0.65), at a dose of 0.1 ng (Exp. 5: exact binomial test: n=23, p=1), or at a dose of 0.01 ng (Exp. 6: exact binomial test: n=23, p=0.21).

These data indicate that 2-MIB at the exceedingly low dose of 1 ng is strongly deterrent to ticks.

### Example 2

In Experiments 7 and 8, parallel testing was conducted to determine whether borneol—which is less costly than 2-MIB—also deters ticks. In each experiment, a watch glass (28 mm diameter) fitted with a congruent piece of filter paper was placed in lateral olfactometer chambers, as shown in FIG. 1. In experiment 7, 1 ng of 2-MIB was dissolved in 25 μL of methanol and applied to the treatment filter paper, and 25 μL of methanol was applied to the corresponding control filter paper. In experiment 8, 1 ng of L-borneol and 1 ng of D-borneol were each dissolved in 25 μL of methanol and applied to the treatment filter paper, and 50 μL of methanol was applied to the control filter paper. In each experimental replicate, methanol was allowed 5 minutes to evaporate before a tick was introduced into the central olfactometer chamber.

As in Example 1, 2-MIB strongly deterred female I. scapularis (Exp. 7: exact binomial test: n=21, p=0.0002). L-Borneol and D-borneol in combination also deterred female I. scapularis (Exp. 8: exact binomial test: n=23, p=0.011).

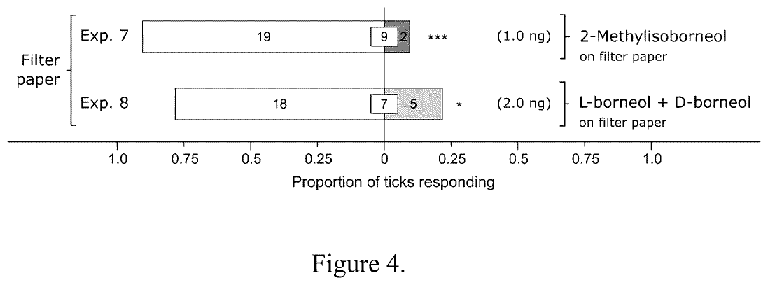

These data, shown in FIG. 4, indicate that both 2-methylisoborneol, and L-borneol and D-borneol in combination, are effective as tick deterrents.

### Example 3

In Experiments 9-11, testing was conducted to determine whether 2-MIB deters not only female I. scapularis (Exp. 9), but also female lone star ticks, Amblyomma americanum (Exp. 10), and female American dog ticks, Dermacentor variabilis (Exp. 11). In each experiment, a watch glass (28 mm diameter) fitted with a congruent piece of filter paper was placed in lateral olfactometer chambers, as shown in FIG. 1, and 1 ng of 2-MIB was dissolved in 25 μL of methanol and applied to the treatment filter paper, and 25 μL of methanol were applied to the corresponding control filter paper. In each experimental replicate, methanol was allowed 5 minutes to evaporate before a tick was introduced into the central olfactometer chamber.

As in Examples 1 and 2, 2-MIB strongly deterred female I. scapularis (Exp. 9: exact binomial test: n=12, p=0.0005). 2-MIB also deterred female A. americanum (Exp. 10: exact binomial test: n=7, p=0.016) and female D. variabilis (Exp. 11: exact binomial test: n=15, p=0.0074).

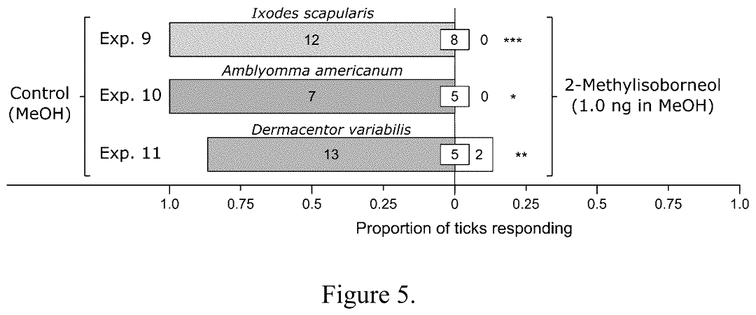

These data, shown in FIG. 5, indicate that 2-MIB is deterrent to multiple species of ticks.

### Example 4

Ixodes scapularis blacklegged ticks spend most of their life taking refuge in leaf litter and detritus. The high humidity and protection from sun afforded by these microhabitats are essential for the survival of ticks which are prone to desiccation. Ticks share these microhabitats, however, with ants that prey on ticks. Ants use diverse chemical signals for communication. In Experiments 12 and 13, testing was performed to determine whether ticks recognize these signals as indicators of ant presence, and thus, avoid locations where these signals are consistently present.

In experiments 12 and 13, both lateral chambers of the olfactometer shown in FIG. 2 were fitted with a piece of filter paper (with a diameter of 90 mm; Cytiva, MA, U.S.A). To collect chemical deposits of Formica oreas worker ants, the glass tube connecting the randomly assigned lateral treatment chamber to the central chamber was blocked with a damp cotton ball, and 20 cold-anaesthetized (−15° C. for 5 min) ants were introduced into the treatment chamber, which was then sealed with parafilm and covered with a petri dish lid, as was the control chamber.

After the ants had roamed for 16 hours in the treatment chamber, both the treatment and the control chamber were ‘unsealed’, and the ants were allowed to leave the treatment chamber on their own accord, thus minimizing agitation. Then, the cotton ball block was removed from the connecting tube, a tick was introduced into the central chamber, the olfactometer was sealed with parafilm, and the bioassay replicate was initiated. Ant-soil filter paper was tested for avoidance responses of female ticks (Exp. 12, n=40) and male ticks (Exp. 13, n=40).

Both female and male ticks were significantly deterred by filter paper soiled with ant chemical deposits (exact binomial tests; Exp. 12: females, n=27, p=0.0015; Exp. 13: males, n=25, p=0.015).

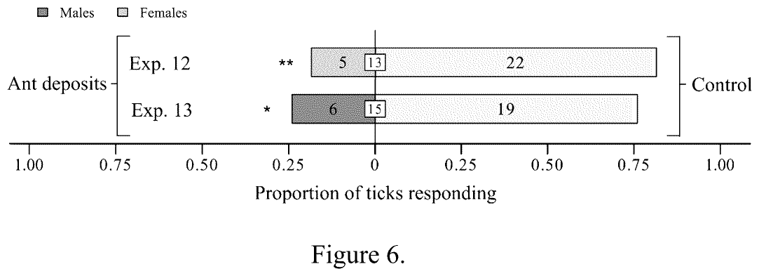

These data, shown in FIG. 6, indicate that ticks recognize chemical communication signals of predatory ants as indicators of ant presence, and that they use these signals to avoid predation by ants.

### Example 5

### Extractions of Poison Gland and Dufour's Glands

Formica oreas worker ants were collected from laboratory colonies, as described above, and cold-euthanized in a −15° C. freezer, where they remained until dissection (e.g., up to 4 days). Ants were dissected in chilled, distilled water under a dissecting microscope (ZEISS Stemi 2000), using fine-tipped forceps (Almedic, FR, CH) and insect pins. In total, 310 poison glands (with reservoirs) and 315 Dufour's glands were excised and placed in separate 4-mL glass vials (VWR International, PA, U.S.A), each containing DCM (1 mL).

To minimize passive emanation of volatile gland constituents from open vials during dissections, vials were kept on ice. To facilitate gland extractions, both samples were first vortexed for 60 seconds to homogenize gland tissues and then kept for 15 minutes at room temperature. Following extractions, samples were filtered through glass wool into clean 4-mL glass vials capped with Teflon-lined lids. To minimize cross-contamination between poison gland and Dufour's gland constituents, all tools were cleaned with DCM between gland excisions, and ruptured glands were omitted. Both filter paper extract and gland extracts were analyzed to determine the origin of chemical constituents in filter paper extract that deterred ticks in experiments 12 and 13, as described in Example 4.

### Effects of Poison Gland Extract and Dufour's Gland Extracts on Behavioural Responses of Ticks

In Experiments 14-19 (n=40 each), avoidance behavior of female and male I. scapularis ticks in response to poison gland extract (Exps. 14, 15), Dufour's gland extract (Exps. 16, 17), and both combined (Exps. 18, 19) was tested against a solvent control. Treatment stimuli were presented at one gland equivalent, as shown in Table 1, dissolved in 500 μL of DCM, whereas an equal volume of DCM was used as the control stimulus. Stimuli were applied dropwise evenly spread across the 90-mm wide filter paper disc in lateral chambers of the olfactometer shown in FIG. 2. After 5 minutes of DCM evaporation, a tick was placed into the central chamber of the olfactometer, and the bioassay was initiated.

TABLE 1
Mean amounts of chemical constituents quantified in poison
and Dufour's gland extracts of Formica oreas worker ants

| Compound | Amount (ng) per gland equivalent | Type of gland |
|---|---|---|
| formic acid | 10,000 | poison |
| undecane | 60,000 | Dufour's |
| tridecane | 5,100 | Dufour's |
| (Z)-4-tridecene | 3,600 | Dufour's |
| heptadecane | 1,140 | Dufour's |
| (Z)-9-tricosene | 900 | Dufour's |
| pentadecane | 840 | Dufour's |
| (Z)-9-nonadecene | 840 | Dufour's |
| (Z)-9-heneicosene | 240 | Dufour's |

Ticks were deterred neither by poison gland extract (exact binomial tests; Exp. 14: females, n=18, p=0.81; Exp. 15: males, n=19, p=0.36) nor by Dufour's gland extract (exact binomial tests; Exp. 16: females, n=20, p=0.82; Exp. 17: males, n=26, p=0.56). However, ticks were significantly deterred by extracts of both the poison gland and the Dufour's gland (exact binomial tests; Exp. 18: females, n=24, p=0.0066; Exp. 19: males, n=23, p<0.001).

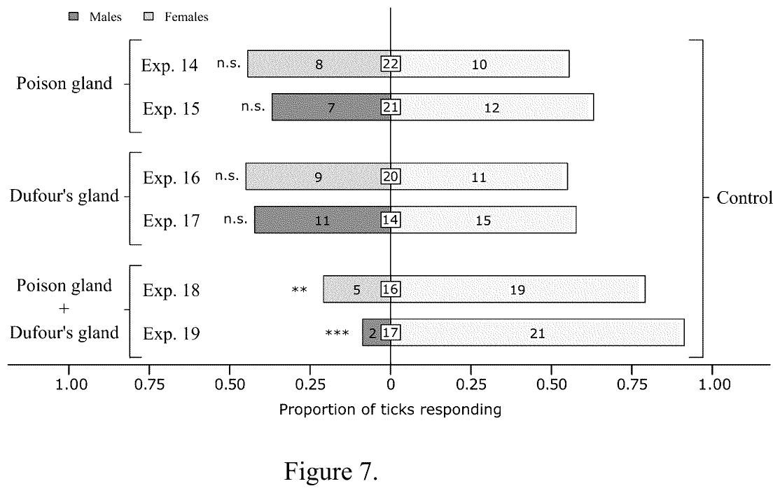

These data, shown in FIG. 7, indicate that constituents of the poison gland extract and the Dufour's gland extract synergistically deter ticks.

### Example 6

Two-microlitre aliquots of poison and Dufour's gland extracts in hexane and DCM were analyzed in splitless mode (with the purge valve open for 0.8 minutes) by gas chromatography-mass spectrometry (GC-MS), using an Agilent 7890B gas chromatograph (GC) fitted with a DB-5 GC-MS column (30 m×0.25 mm ID, film thickness 0.25 μm), and coupled to a 5977A Mass Selective Detector (MSD). The GC injector port was set to a temperature of 250° C., the MS source was set to a temperature of 230° C., and the MS quadrupole was set to a temperature of 150° C. With helium as the carrier gas (at a flow rate: 35 cm s⁻¹), the following temperature program was used: 40° C., held for 5 minutes; and 10° C. min⁻¹ to 280° C. (held for 10 minutes).

Compounds in extracts were identified by comparing their retention indices and mass spectra with those of authentic standards that were purchased or synthesised. Double bond positions in unsaturated hydrocarbons were determined by treating aliquots of extracts with dimethyl disulfide (DMDS), and by analysing DMDS derivatives for double bond positions. To test for the presence of formic acid in poison gland extract which chromatographs poorly and thus is easily missed or incorrectly quantified, further aliquots of extracts were treated with 1-decanol to derivatize formic acid to decyl formate which readily chromatographs.

Because derivatization of formic acid to decyl formate enabled detection, but not accurate quantification, of formic acid in poison gland extract, formic acid was quantified instead using a 7964 Agilent Headspace Sampler coupled to a Varian 2000 Ion Trap GC-MS fitted with a DB-FATWAX Ultra Inert GC column (30 m×0.25 mm ID). To this end, we applied one gland equivalent of poison gland extract to filter paper (Cytiva, MA, U.S.A) in a 20-mL vial, which was then sealed with a 20-mm OD silicon septum and a crimped cap. The vial was heated to a temperature of 150° C., and headspace volatiles were withdrawn with an automated syringe and subjected to GC-MS analysis, using the following temperature program: 40° C. held for 10 minutes; then 10° C. min⁻¹ until 200° C.

GC-MS analyses of gland extracts in DCM, before and after chemical derivatization, revealed the presence of formic acid in poison gland extracts and of hydrocarbons in Dufour's gland extracts. As shown in Table 1, of all compounds detected, formic acid was most abundant followed, in order of decreasing abundance, by undecane, tridecane, (Z)-4-tridecene, heptadecane, (Z)-9-tricosene, pentadecane, (Z)-9-nonadecene, and (Z)-9-heneicosene.

As the results of Example 5 demonstrated that poison gland extract and Dufour's gland extract, in combination, deter ticks, Experiments 20-25 tested avoidance behavior of female and male I. scapularis ticks in response to synthetic equivalents of compounds present in poison gland extract (Exps. 20, 21), Dufour's gland extract (Exps. 22, 23), and both combined (Exp. 24, 25). Like gland extracts, synthetic blends were tested at one gland equivalent and applied in 500 μL of DCM, with the same volume of DCM serving as the control stimulus.

Ticks were deterred neither by formic acid (poison gland constituent) (exact binomial tests; Exp. 20: females, n=32, p=0.60; Exp. 21: males, n=32, p=0.11) nor by hydrocarbons (Dufour's gland constituents) (exact binomial tests; Exp. 22: females, n=32, p=0.60; Exp. 23: males, n=36, p=1.0). Formic acid and hydrocarbons in binary combination, however, deterred ticks (exact binomial tests; Exp. 24: females, n=30, p=0.043; Exp. 25: males, n=33, p=0.035).

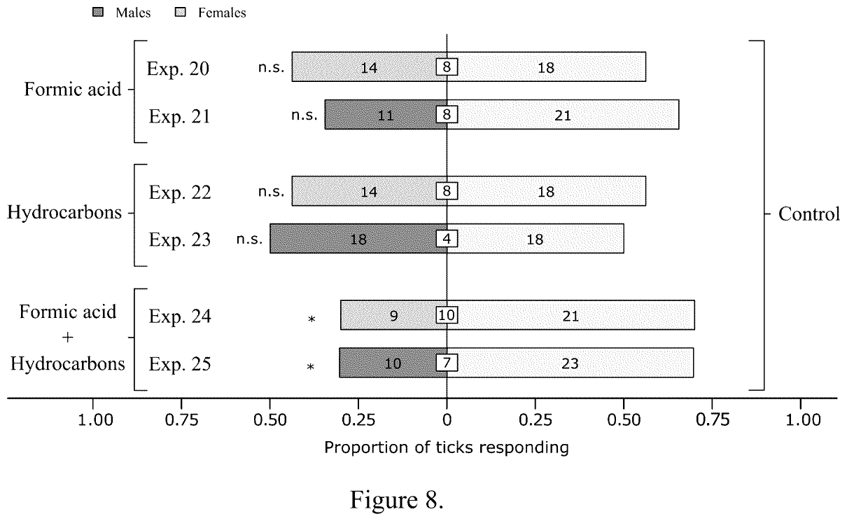

These data, shown in FIG. 8, indicate that synthetic constituents of the poison gland extract and the Dufour's gland extract synergistically deter ticks.

As used herein, all percentages (%) are expressed as weight by volume (w/v), the mass of solute divided by the volume of the solution multiplied by 100, or simply as %.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A tick repellent comprising:
one or more of 2-methylisoborneol (2-MIB), D-borneol, L-borneol, and a blend of formic acid, undecane, tridecane, (Z)-4-tridecene, heptadecane, (Z)-9-tricosene, pentadecane, (Z)-9-nonadecene, and (Z)-9-heneicosene; and
a carrier material.

2. The tick repellent of claim 1, wherein the carrier liquid is an organic solvent or an inert material.

3. The tick repellent of claim 1 comprising 2-MIB.

4. The tick repellent of claim 3, wherein the carrier liquid is methanol.

5. The tick repellent of claim 3 comprising about 0.0000004% (w/v) of 2-MIB or more.

6. The tick repellent of claim 3, wherein the 2-MIB is isolated, purified, or synthetic.

7. The tick repellent of claim 1 comprising a blend of D-borneol and L-borneol.

8. The tick repellent of claim 7 comprising about 0.0000004% (w/v) of D-borneol or more and about 0.0000004% (w/v) of L-borneol or more.

9. The tick repellent of claim 7, wherein the carrier liquid is methanol.

10. The tick repellent of claim 1 comprising the blend of formic acid, undecane, tridecane, (Z)-4-tridecene, heptadecane, (Z)-9-tricosene, pentadecane, (Z)-9-nonadecene, and (Z)-9-heneicosene.

11. The tick repellent of claim 10, wherein the carrier liquid is dichloromethane (DCM).

12. The tick repellent of claim 10, wherein the components of the blend of formic acid, undecane, tridecane, (Z)-4-tridecene, heptadecane, (Z)-9-tricosene, pentadecane, (Z)-9-nonadecene, and (Z)-9-heneicosene are isolated, purified, or synthetic.

13. The tick repellent of claim 1, wherein the ticks are soft ticks.

14. The tick repellent of claim 1, wherein the ticks are hard ticks.

15. The tick repellent of claim 14, wherein the ticks are of the species selected from the group consisting of Ixodes scapularis, Amblyomma americanum, and Dermacentor variabilis.

16. A personal care product for topical application formed from the tick repellent of claim 1.

17. A method of controlling ticks comprising:
dispensing a tick repellent;
wherein the tick repellent comprises:
one or more of 2-methylisoborneol (2-MIB), D-borneol, L-borneol, and a blend of formic acid, undecane, tridecane, (Z)-4-tridecene, heptadecane, (Z)-9-tricosene, pentadecane, (Z)-9-nonadecene, and (Z)-9-heneicosene; and
a carrier material.

18. The method of claim 17, wherein dispensing the tick repellent comprises topically applying the tick repellent to a user's skin, clothing, shoes, and/or backpack.

19. The method of claim 17, wherein dispensing the tick repellent comprises applying the tick repellent on or alongside trails.

20. The method of claim 17 further comprising providing a device for repelling one or more tick species, wherein the tick repellent is dispensed from the device.
